(19) United States
(12) Patent Application Publication
(10) Pub. No.: US 2004/0064921 A1
(43) Pub. Date: Apr. 8, 2004

(54) Binder lock system

(76) Inventor: Stacy L. Mittleider, Freeman, SD (US)

Correspondence Address: Michael S. Neustel, Suite No.4, 2534 South University Drive, Fargo, ND, 58103, US

(21) Appl. No.: 10/267,138

(22) Filed: Oct. 7, 2002

(51) Int. Cl. F16B 19/00; A44B 21/00

(52) U.S. Cl. 24/68 CT

(57) ABSTRACT

A binder lock system for securing a chain binder in a safe manner. The binder lock system includes a cuff member, a first aperture and a second aperture aligned within the distal portion of cuff member, and a locking pin positionable within the first aperture and the second aperture within a link of a first chain. The cuff member is formed to fit about the elongate handle of the chain binder.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to chain binder devices and more specifically it relates to a binder lock system for securing a chain binder in a safe manner.

2. Description of the Related Art

Chain binders have been in use for years for securing loads upon trailers, vehicles and other structures. A conventional chain binder has an elongate handle, a first shaft pivotally attached to the elongate handle in a leveraged manner with a first hook, and a second shaft pivotally attached to the elongate handle with a second hook. The first hook is secured to a first chain and the second hook is secured to a second chain as shown in FIG. 2 of the drawings. The user leverages the elongate handle of the chain binder thereby drawing the first chain and the second chain together until the elongate handle is properly leveraged into a locked position as shown in FIG. 1 of the drawings.

The main problem with conventional chain binders is that the elongate handle may accidentally be removed from the locked position for various reasons. Another problem with conventional chain binders is that a load upon the trailer or vehicle may be lost because of accidental opening of the chain binder.

Examples of patented devices which may be related to the present invention include U.S. Pat. No. 4,693,097 to Rivera; U.S. Pat. No. 3,954,252 to Lyons; U.S. Pat. No. 2,564,821 to Smith; U.S. Pat. No. 257,263 to Wood; U.S. Pat. No. 1,230,146 to Frieze; U.S. Pat. No. 2,759,235, to Rea; U.S. Pat. No. 2,894,412 to Kaeser; U.S. Pat. No. 2,947,514 to Goss; U.S. Pat. No. 5,002,002 to Awalt, Jr.; U.S. Pat. No. 3,789,464 to Collanus; U.S. Pat. No. 3,811,655 to Foster; U.S. Pat. No. 4,054,971 to Kawahara; U.S. Pat. No. 4,683,923 to Harris; and U.S. Pat. No. 632,704 to Fantroy.

While these devices may be suitable for the particular purpose to which they address, they are not as suitable for securing a chain binder in a safe manner. Conventional chain binders do not provide a means for ensuring that they will not be accidentally opened.

In these respects, the binder lock system according to the present invention substantially departs from the conventional concepts and designs of the prior art, and in so doing provides an apparatus primarily developed for the purpose of securing a chain binder in a safe manner.

### BRIEF SUMMARY OF THE INVENTION

In view of the foregoing disadvantages inherent in the known types of chain binders now present in the prior art, the present invention provides a new binder lock system construction wherein the same can be utilized for securing a chain binder in a safe manner.

To attain this, the present invention generally comprises a cuff member, a first aperture and a second aperture aligned within the distal portion of cuff member, and a locking pin positionable within the first aperture and the second aperture within a link of a first chain. The cuff member is formed to fit about the elongate handle of the chain binder.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a binder lock system that will overcome the shortcomings of the prior art devices.

A second object is to provide a binder lock system for securing a chain binder in a safe manner.

Another object is to provide a binder lock system that may be utilized upon various styles and sizes of chain binders.

An additional object is to provide a binder lock system that does not require a significant amount of time to secure to a chain binder.

A further object is to provide a binder lock system that prevents a chain binder from accidentally opening from a locked position.

Another object is to provide a binder lock system that reduces the chances of losing a load during transportation.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is side view of a conventional chain binder attached to a first chain and a second chain in a locked position.

FIG. 2 is an exploded side view of the present invention and the conventional chain binder attached to a first chain and a second chain.

FIG. 3 is a perspective view of the present invention positioned about the elongate handle of the chain binder.

FIG. 4 is a perspective view of the present invention with the locking pin inserted.

FIG. 5 is a perspective view of the present invention with the locking member secured about the locking pin.

FIG. 6 is an upper perspective view of the present invention.

FIG. 7 is an exploded upper perspective view of the present invention.

### DETAILED DESCRIPTION OF THE INVENTION

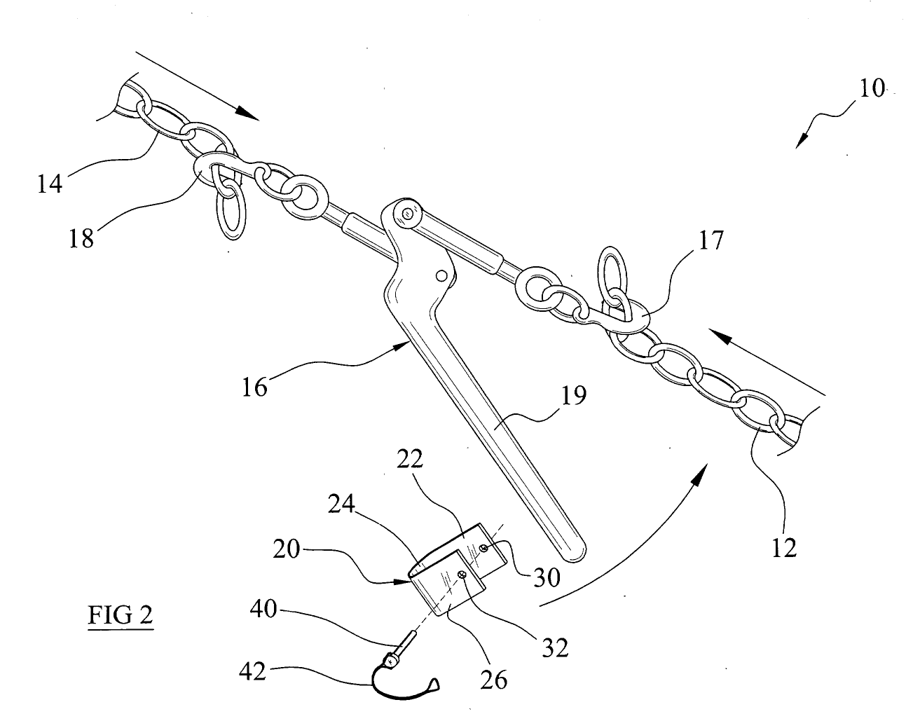

Turning now descriptively to the drawings, in which similar reference characters denote similar elements throughout the several views, FIGS. 2 through 7 illustrate a binder lock system 10, which comprises a cuff member 20, a first aperture 30 and a second aperture 32 aligned within the distal portion of cuff member 20, and a locking pin 40 positionable within the first aperture 30 and the second aperture 32 within a link of a first chain 12. The cuff member 20 is formed to fit about the elongate handle 19 of the chain binder 16.

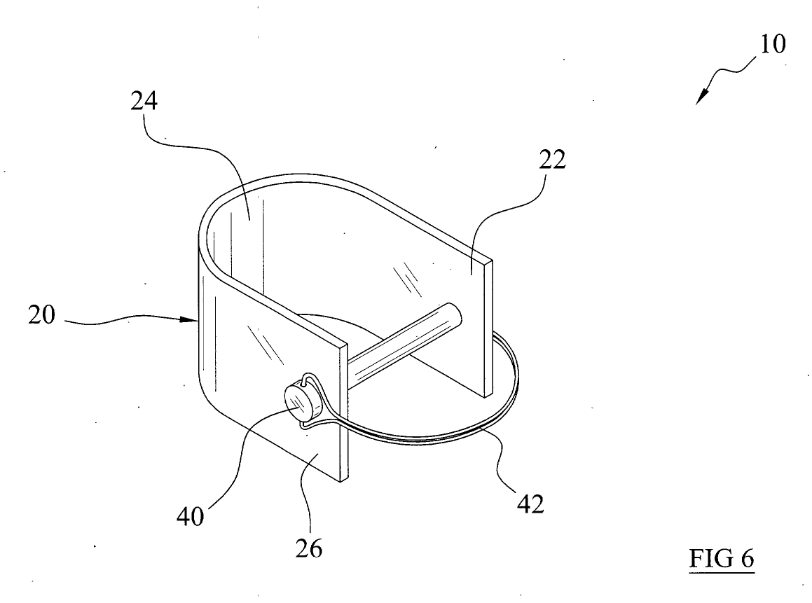

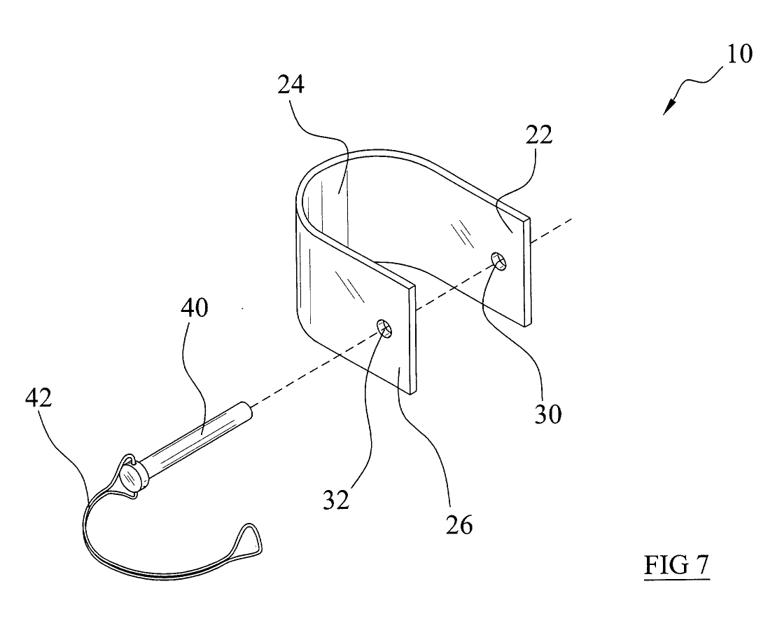

As best shown in FIGS. 6 and 7 of the drawings, the cuff member 20 has a generally U-shaped structure. The cuff member 20 has a first portion 22, a middle portion 24 and a second portion 26 formed into a continuous U-shaped structure. The middle portion 24 is preferably comprised of a curved structure, however the middle portion 24 may have various other shapes as desired. The first portion 22 and the second portion 26 are preferably substantially parallel to one another, however the first portion 22 and the second portion 26 may be at an angle with respect to one another.

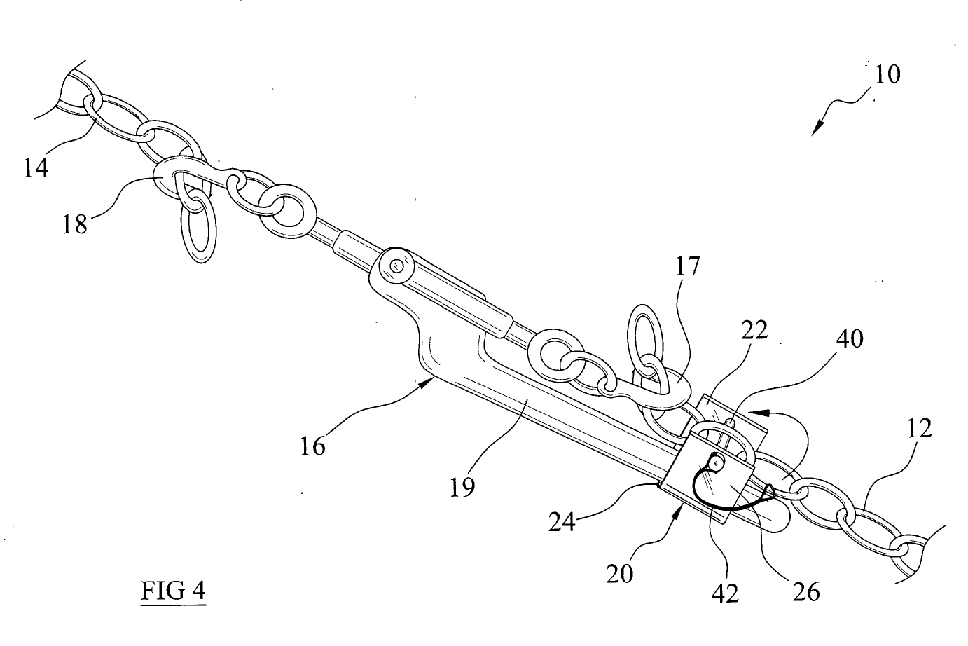

The cuff member 20 is preferably comprised of a rigid material such as but not limited to metal, composite, fiberglass or plastic. The cuff member 20 may have varying thickness and widths depending upon the forces expected to be encountered. The length of the first portion 22 and the second portion 26 is sufficient for allowing surrounding of the elongate handle 19 of the chain binder 16 and extending at least a finite distance adjacent to a link within the first chain 12 as best shown in FIG. 4 of the drawings.

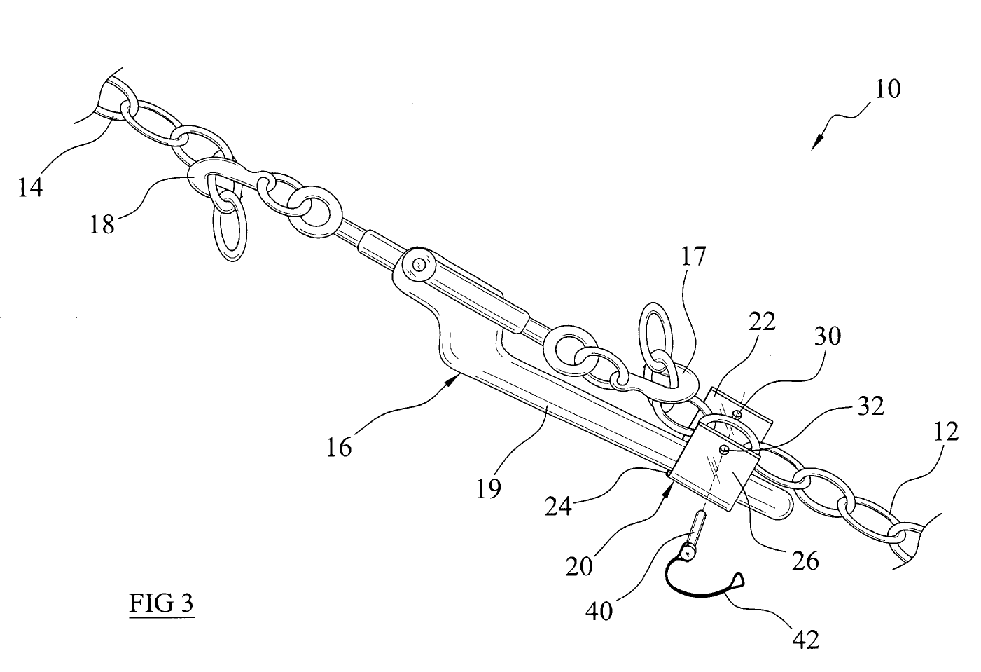

As shown in FIGS. 3 and 7 of the drawings, a first aperture 30 and a second aperture 32 extend through the first portion 22 and the second portion 26 respectively of the cuff member 20. The first aperture 30 and the second aperture 32 are preferably aligned with one another as best illustrated in FIG. 7 of the drawings. Additional pairs of apertures may be positioned within the cuff member 20 for providing adjustable securing to the first chain 12.

The locking pin 40 is comprised of an elongate structure that is extendable through the first aperture 30 and the second aperture 32 in a removable manner. The locking pin 40 may be comprised of various elongate structures such as a solid pin, threaded fasteners and the like. A locking member 42 is preferably attached to the head of the locking pin 40 for allowing securing of the locking pin 40 within the cuff member 20 as best illustrated in FIGS. 6 and 7 of the drawings. FIGS. 6 and 7 illustrate the usage of a spring clip pivotally attached to the locking pin 40 for the locking member 42, however various other locking devices may be utilized such as a threaded nut or an aperture within the distal end of the locking pin 40 with a pin member removably inserted within thereof.

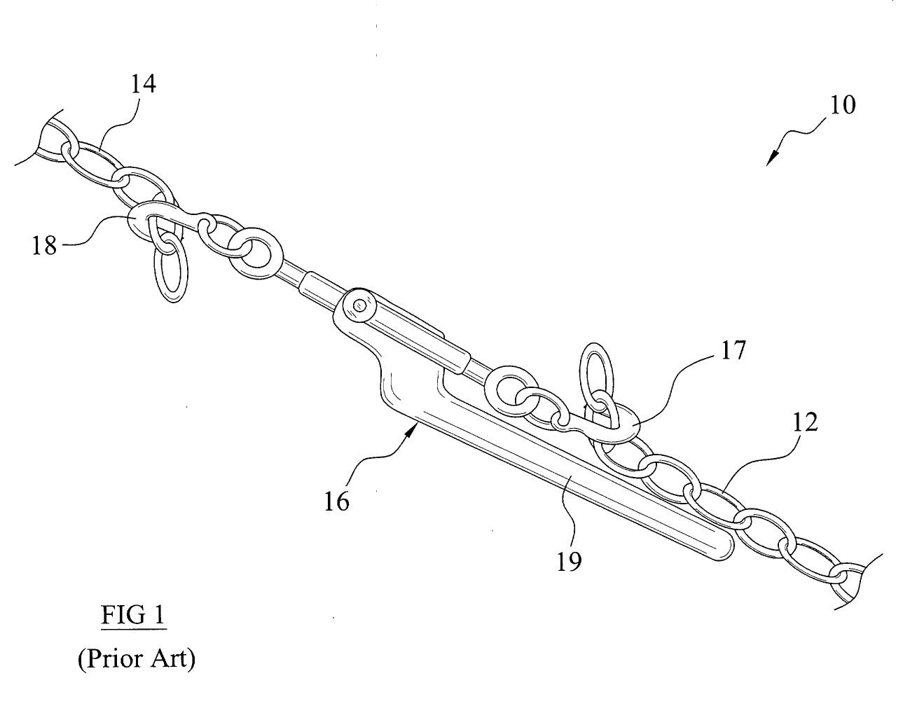

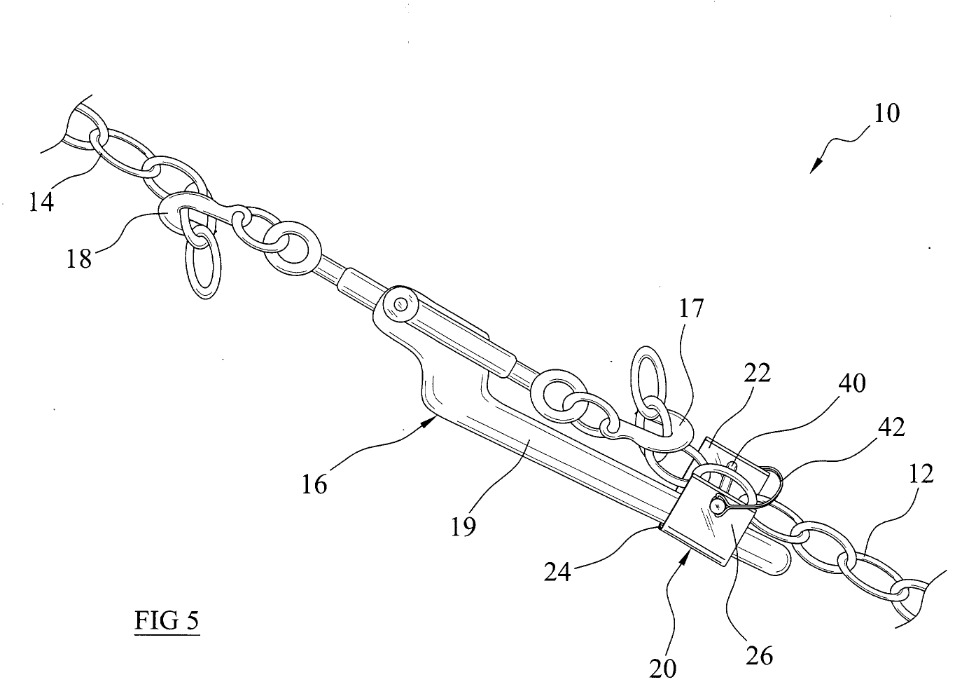

In use, the user first attaches the first hook 17 of the chain binder 16 to the first chain 12 and the second hook 18 of the chain binder 16 to the second chain 14 as illustrated in FIG. 2 of the drawings. The user then manipulates the elongate handle 19 of the chain binder 16 towards the first chain 12 until the chain binder 16 passes the leverage point thereby locking the chain binder 16 as shown in FIG. 1 of the drawings. The user then positions the cuff member 20 about the elongate handle 19 as shown in FIG. 3 of the drawings. The user then inserts the locking pin 40 through the first aperture 30, then through a link within the first chain 12 and then through the second aperture 32 as shown in FIG. 4 of the drawings. The user then secures the locking member 42 upon the locking pin 40 to ensure non-removal of the locking pin 40 from the cuff member 20 as illustrated in FIG. 5 of the drawings. The cuff member 20 prevents the elongate handle 19 from moving away from the first chain 12 and thereby retains the chain binder 16 in the desired locked position. When the user desires to release the chain binder 16, the locking pin 40 is removed from the cuff member 20 and the cuff member 20 is then removed from the elongate handle 19.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A binder lock system for securing a chain binder in a locked position, comprising:
a cuff member having a U-shaped structure;
a first aperture extending through a first portion of said cuff member;
a second aperture extending through a second portion of said cuff member; and
a locking pin removably extendable within said first aperture, a chain link of a first chain and said second aperture when said cuff member is positioned about an elongate handle of said cuff member.

2. The binder lock system of claim 1, wherein said cuff member has a middle portion between said first portion and said second portion.

3. The binder lock system of claim 2, wherein said middle portion has a curved structure.

4. The binder lock system of claim 1, wherein said locking pin includes a locking member connectable to said locking pin.

5. The binder lock system of claim 4, wherein said locking member is a spring clip pivotally attached to a head of said locking pin.

6. The binder lock system of claim 1, wherein said first portion and said second portion are substantially parallel to one another.

7. The binder lock system of claim 1, wherein said cuff member is comprised of a rigid material.

8. The binder lock system of claim 7, wherein said cuff member is comprised of a metal material.

9. The binder lock system of claim 1, wherein said first aperture is aligned concentrically with said second aperture.

10. A method of securing a binder lock unit having a cuff member having a U-shaped structure, a first aperture extending through a first portion of said cuff member, a second aperture extending through a second portion of said cuff member, and a locking pin, said method comprising the steps of:
(a) securing a first hook of a chain binder upon a first chain;
(b) securing a second hook of said chain binder upon a second chain;
(c) manipulating an elongate handle of said chain binder to a leveraged locked position;
(d) positioning said cuff member about said elongate handle; and
(e) extending said locking pin through said first aperture, then a link of said first chain and said second aperture.

11. The method of securing a binder lock unit of claim 10, said method including the step of (f) attaching a locking member to said locking pin.

12. The method of securing a binder lock unit of claim 10, wherein said cuff member is positioned near a distal portion of said elongate handle.
